(19) United States
(12) Patent Application Publication
(10) Pub. No.: US 2026/0142697 A1
(43) Pub. Date: May 21, 2026

(54) RADIO NETWORK NODE, AND METHOD PERFORMED THEREIN

(71) Applicant: Telefonaktiebolaget LM Ericsson (publ), Stockholm (SE)

(72) Inventors: Zhao WANG, Taeby (SE); Wei ZHOU, Beijing (CN); Lin YAO, Beijing (CN)

(73) Assignee: Telefonaktiebolaget LM Ericsson (publ), Stockholm (SE)

(21) Appl. No.: 19/123,374

(22) PCT Filed: Oct. 25, 2022
(86) PCT No.: PCT/CN2022/127302

§ 371 Date: Apr. 22, 2025

(51) Int. Cl. H04B 7/0456; H04B 17/26; H04L 5/00; H04W 28/02; H04W 72/0446

(52) U.S. Cl. CPC H04B 7/0456; H04B 17/26; H04L 5/0048; H04W 28/0236; H04W 72/0446

(57) ABSTRACT

Embodiments herein relate to, for example, a method performed by a radio network node (12) for handling communication in a wireless communication network. The radio network node (12) determines a time correlation coefficient in a channel time correlation function, and then schedules one or more resources for a UE (10) taking the time correlation coefficient into account.

### TECHNICAL FIELD

Embodiments herein relate to a radio network node, and method performed therein regarding wireless communication. Furthermore, a computer program and a computer readable storage medium are also provided herein. In particular, embodiments herein relate to handling communication, such as handling resources for a user equipment (UE), in a wireless communications network.

### BACKGROUND

In a typical wireless communications network, UEs, also known as wireless communication devices, mobile stations, stations (STA) and/or wireless devices, communicate via a Radio Access Network (RAN) with one or more core networks (CN). The RAN covers a geographical area which is divided into service areas or cells, with each service area or cell being served by a radio network node such as an access node e.g. a Wi-Fi access point or a radio base station (RBS), which in some networks may also be called, for example, a NodeB, a gNodeB, or an eNodeB. The service area or cell is a geographical area where radio coverage is provided by the radio network node. The radio network node operates on radio frequencies to communicate over an air interface with the UEs within range of the radio network node. The radio network node communicates over a downlink (DL) to the UE and the UE communicates over an uplink (UL) to the radio network node.

A Universal Mobile Telecommunications System (UMTS) is a third generation (3G) telecommunication network, which evolved from the second generation (2G) Global System for Mobile Communications (GSM). The UMTS terrestrial radio access network (UTRAN) is essentially a RAN using wideband code division multiple access (WCDMA) and/or High-Speed Packet Access (HSPA) for communication with user equipment. In a forum known as the Third Generation Partnership Project (3GPP), telecommunications suppliers propose and agree upon standards for present and future generation networks and investigate e.g. enhanced data rate and radio capacity. In some RANs, e.g. as in UMTS, several radio network nodes may be connected, e.g., by landlines or microwave, to a controller node, such as a radio network controller (RNC) or a base station controller (BSC), which supervises and coordinates various activities of the plural radio network nodes connected thereto. The RNCs are typically connected to one or more core networks.

Specifications for the Evolved Packet System (EPS) have been completed within the 3GPP and coming 3GPP releases, such as New Radio (NR), are worked on. The EPS comprises the Evolved Universal Terrestrial Radio Access Network (E-UTRAN), also known as the Long-Term Evolution (LTE) radio access network, and the Evolved Packet Core (EPC), also known as System Architecture Evolution (SAE) core network. E-UTRAN/LTE is a 3GPP radio access technology wherein the radio network nodes are directly connected to the EPC core network. As such, the Radio Access Network (RAN) of an EPS has an essentially “flat” architecture comprising radio network nodes connected directly to one or more core networks.

With the emerging 5G technologies such as new radio (NR), the use of very many transmit- and receive-antenna elements may be of great interest as it makes it possible to utilize beamforming, such as transmit-side and receive-side beamforming. Transmit-side beamforming means that the transmitter can amplify transmitted signals in a selected direction or directions, while suppressing transmitted signals in other directions. Similarly, on the receive-side, a receiver can amplify signals from a selected direction or directions, while suppressing unwanted signals from other directions.

Multiple-input-multiple-output (MIMO) communication is a technique to serve several users simultaneously with the same time and frequency resource in a wireless communication network. This technique, in which the gNB and/or the UEs are equipped with multiple antennas, enables spatial diversity when transmitting data in both uplink (UL) and downlink (DL) directions. The obtained spatial diversity increases the capacity of the network dramatically, or equivalently one can say that it offers a more efficient utilization of the frequency spectrum. Moreover, MIMO can reduce the inter-cell and intra-cell interferences which in turn, leads to more frequency re-use. As the electromagnetic spectrum is a rare resource, MIMO is a vital solution for the extension of the capacity of wireless communication systems.

### Reciprocity-Based Precoding in MIMO.

A key point for effective deployment of the MIMO communication technology is the access to estimate of the channel responses between the gNB and the users in the associated network cell, which is usually called channel state information (CSI). These channel responses include those in DL and UL transmissions and help to form the beam from the gNB toward the intended UEs. The channel in the UL direction is usually estimated using pilot symbols, such as reference signals, sent by the UEs and received by the gNB (often called “sounding” and for example implemented as Sounding Reference Symbols (SRS) in 3GPP LTE and NR).

For a time division duplex (TDD)-based system, it is possible to apply the physical channel property of reciprocity and use the UL sounding and channel estimation to obtain the DL channel estimates as well. The DL channel estimates, consequently, can be used to calculate the weight for the beamforming. In fact, the reciprocity-based algorithms for beamforming in the downlink transmission are amongst the most successfully exploited algorithms in MIMO and are predicted to be widely exploited in the fifth generation of cellular wireless communication networks. This class of algorithms is applicable whenever the so-called channel reciprocity holds. More precisely, it is assumed that the channel frequency response between two antennas in the uplink is the same as the channel frequency response in the downlink multiplied by a constant complex scalar. Using this fact, the estimated channel in the uplink is used to decide the direction for beamforming in the downlink. This principle holds when time-division multiplexing is used for sharing data transmission time between the DL and UL transmissions.

### MU-MIMO and Channel Aging.

Multiuser MIMO (MU-MIMO) is a technique where several users are served by the same transmit antennas within the same time-frequency resources. As the gNB here transmits data to more than one user within the same resources, the users will receive not only their own data, but also interference of the data to the other users. Precoding techniques can be used to mitigate this interference while increasing the signal to interference and noise ratio (SINR) of the desired data at each user and thus achieving high spectral efficiency for MU-MIMO systems. For these techniques to work, high accuracy of channel knowledge is required to design efficient beamforming solutions.

Channel accuracy is especially crucial for MU-MIMO as compared to single user MIMO (SU-MIMO) where only the beamforming gain is required. Considering the channel aging due to the UE mobility, the precoder which is calculated based on the UL channel estimation in the given slot might mismatch with corresponding DL slot. How to solve the mismatch is a difficult study topic.

### Channel Prediction Based on SRS.

Even though it is possible to obtain the CSI based on channel reciprocity from uplink channel estimation, two facts have great impact of the CSI accuracy: noise and interference on the reference signals which degrades the channel estimation performance, and the mismatch from the uplink measurement with the downlink ground truth channel. Embodiments focus on the latter aspect caused by UE mobility and SRS processing delay.

Due to the following reasons, the estimated channel from uplink sounding may be outdated when applied for designing a downlink precoder which is used for downlink data transmission.
TDD frame structure
   TDD transmission switches between downlink and uplink transmission in time domain. If it is a downlink heavy TDD configuration, then the estimated channel, based on uplink slot, will be outdated for the following downlink transmission slots. A TDD pattern example is shown in FIG. 1. Here, slots 7,8,9 are reserved for uplink channel estimation. The estimated channel will then be outdated for the following slots, indexed by 10 to 16. For fast fading channels, it is expected that the channels vary significantly from the uplink measurement to DL transmission, e.g., because of Doppler, UE mobility, and the changes of propagation environment.

FIG. 1 shows an example of a TDD frame structure.
SRS configurations with large SRS transmission periodicity to address the SRS capacity issue
   When the number of UEs scheduled to transmit SRS signal is large, it will be quite challenging to allow every UE to transmit SRS signal during a single uplink transmission occasion. The reason behind this is that the SRS transmission capacity of each uplink transmission occasion is limited. In other words, to allow more UEs to have SRS transmission opportunities, network needs to increase the SRS transmission periodicity. As a by-product, for each UE, SRS transmission occasions will be far apart. For example, the SRS transmission periodicity may be configured as 20 milliseconds, even though every 5 ms there may be uplink transmission occasion.
SRS processing delay in baseband
   Because of the computational limitation, a certain milliseconds of processing delay exists before obtaining the channel estimation based on the sounding reference signals. For example, by receiving the SRS at slot 7, it might be so that DL transmission can utilize the channel estimate after slot 13 due to 6 slots processing delay. The channel may vary during this time duration.
UE in high velocity
   The severity of the CSI outdating caused by the abovementioned facts depends on the UE velocity. If a UE is stationary, then the channel is likely to remain close to constant during a long period of time and the outdating will generally not be an issue. However, when a UE is moving, the CSI experienced by the UE will be changing slot by slot. Then, the outdating issue will become severe, especially when the UE is in high velocity.

In the prevalent radio access technology (RAT) transmission, the uplink channel estimation will be directly applied for downlink precoder calculation. Due to the velocity increase of UE, the aging of the CSI will degrade the RAT performance.

### SUMMARY

As part of developing embodiments herein, one or more problems were first identified. Embodiments herein aim to provide a scheduling solution to combat channel aging for beamforming enhancement. In order to combat channel aging, different methods of channel prediction have been explored in the recent years. The principal idea of channel prediction is to make accurate channel estimations/predictions of the slots for DL transmissions based on the historical channel states, in order to catch up with the fast fading.

However, with the baseband processing delay for channel estimation and prediction, the prediction performance may be limited because the DL transmission slot may be less correlated with the historical channel states estimated from UL. How to further enhance the channel prediction with complexity and real-time processing constraints is still challenging in practice. Hence, existing solutions try to decrease UL channel estimation processing delay as much as possible, which leads to stringent constraints during implementation.

As a newly arisen issue for the 5G network, how to enhance massive MIMO performance is still an open research and development area, and aspects such as channel estimation/prediction, beamforming, and scheduling are of interest.

An object herein is to provide a mechanism to handle resources for communication of a UE in an efficient manner in a wireless communications network.

According to an aspect the object is achieved, according to embodiments herein, by providing a method performed by a radio network node for handling communication in a wireless communication network. The radio network node determines a time correlation coefficient in a channel time correlation function; and then schedules one or more resources for a UE taking the time correlation coefficient into account.

According to a further aspect, the object is achieved by providing a radio network node configured to perform the methods herein.

Thus, it is herein provided a radio network node for handling communication in a wireless communication network. The radio network node is configured to determine a time correlation coefficient in a channel time correlation function; and then to schedule one or more resources for a UE taking the time correlation coefficient into account.

It is furthermore provided herein a computer program product comprising instructions, which, when executed on at least one processor, cause the at least one processor to carry out the methods herein, as performed by the radio network node. It is additionally provided herein a computer-readable storage medium, having stored thereon a computer program product comprising instructions which, when executed on at least one processor, cause the at least one processor to carry out the methods herein, as performed by the radio network node.

Embodiments herein improve the spectral efficiency of the band since all the UEs are scheduled according to their respective optimal slots which provide strong channel time correlation with SRS slots, or the DL slots when CSI is measured.

The proposed solution may take into account the CSI processing or feedback delay for better scheduling decision, instead of placing a stringent requirement. Therefore, it is feasible to implement. Thus, the communication of a UE is handled in an efficient manner in the wireless communications network.

### BRIEF DESCRIPTION OF THE DRAWINGS

Embodiments will now be described in more detail in relation to the enclosed drawings, in which:

FIG. 1 shows an example of a TDD frame structure according to prior art;

FIG. 2 shows an overview depicting a wireless communications network according to embodiments herein;

FIG. 3 shows a combined signalling scheme and flowchart depicting embodiments herein;

FIG. 4 shows a flowchart depicting a method performed by a radio network node according to embodiments herein;

FIG. 5 shows a solution principle according to some embodiments herein;

FIG. 6 shows a flowchart according to some embodiments herein;

FIG. 7 shows a flowchart according to some embodiments herein;

FIGS. 8a-8d show estimated channel time autocorrelation function of 4 different channel cases;

FIG. 9 shows relationship between throughput and channel estimation processing delay according to embodiments herein;

FIG. 10 shows throughput in relation to a delay parameter according to embodiments herein;

FIG. 11 shows a block diagram depicting embodiments of a radio network node according to embodiments herein;

FIG. 12 schematically illustrates a telecommunication network connected via an intermediate network to a host computer;

FIG. 13 is a generalized block diagram of a host computer communicating via a base station with a user equipment over a partially wireless connection; and

FIGS. 14, 15, 16, and 17 are flowcharts illustrating methods implemented in a communication system including a host computer, a base station, and a user equipment.

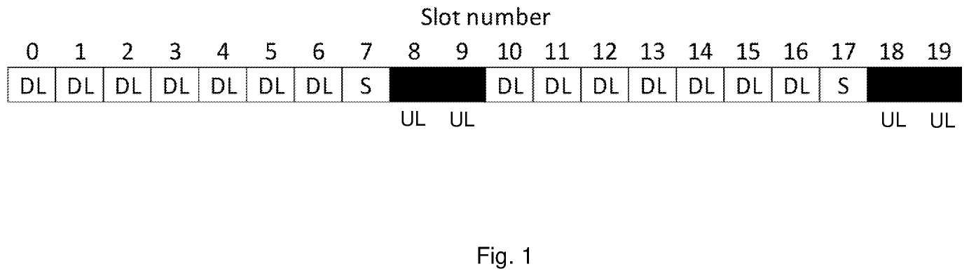

### DETAILED DESCRIPTION

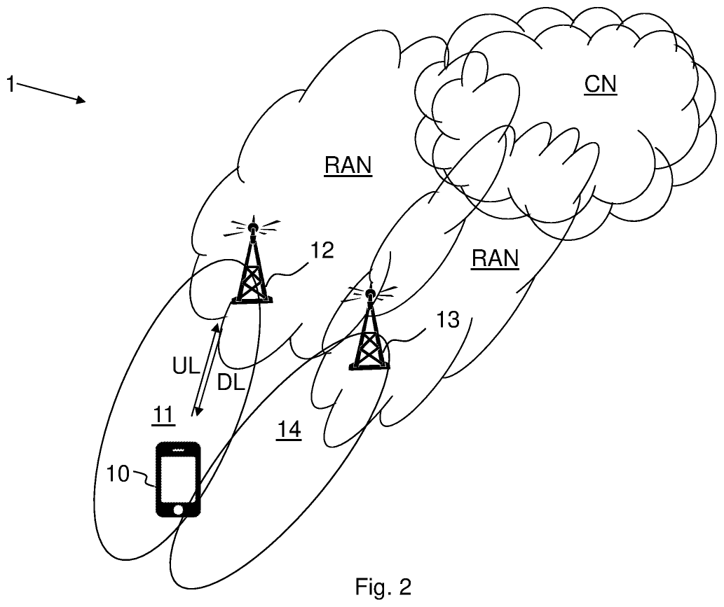

Embodiments herein relate to wireless communications networks in general. FIG. 2 is a schematic overview depicting a wireless communications network 1. The wireless communications network 1 comprises one or more access networks, such as RANs, and one or more CNs. The wireless communications network 1 may use one or a number of different technologies. Embodiments herein relate to recent technology trends that are of particular interest in a New Radio (NR) context, however, embodiments are also applicable in further development of existing wireless communications systems such as e.g. LTE or Wideband Code Division Multiple Access (WCDMA).

In the wireless communications network 1, a user equipment (UE) 10 exemplified herein as a wireless device such as a mobile station, a non-access point (non-AP) station (STA), a STA and/or a wireless terminal, is comprised communicating via e.g. one or more Access Networks (AN), e.g. radio access network (RAN), to one or more core networks (CN). It should be understood by the skilled in the art that “UE” is a non-limiting term which means any terminal, wireless communications terminal, user equipment, narrowband internet of things (NB-IoT) device, Machine Type Communication (MTC) device, Device to Device (D2D) terminal, or node e.g. smart phone, laptop, mobile phone, sensor, relay, mobile tablets or even a small base station capable of communicating using radio communication with a radio network node within an area served by the radio network node.

The wireless communications network 1 comprises a first radio network node 12 providing radio coverage over a geographical area, a first service area 11 or first cell, of a first radio access technology (RAT), such as NR, LTE, or similar. The first radio network node 12 may be a transmission and reception point such as an access node, an access controller, a base station, e.g. a radio base station such as a gNodeB (gNB), an evolved Node B (eNB, eNode B), a NodeB, a base transceiver station, a radio remote unit, an Access Point Base Station, a base station router, a Wireless Local Area Network (WLAN) access point or an Access Point Station (AP STA), a transmission arrangement of a radio base station, a stand-alone access point or any other network unit or node capable of communicating with a wireless device within the area served by the radio network node depending e.g. on the first radio access technology and terminology used. The first radio network node 12 may be referred to as a serving or source radio network node, wherein the service area may be referred to as a serving cell, and the serving network node communicates with the wireless device in form of DL transmissions to the wireless device and UL transmissions from the wireless device. It should be noted that a service area may be denoted as cell, beam, beam group or similar to define an area of radio coverage.

The wireless communications network 1 comprises a second radio network node 13 providing radio coverage over a geographical area, a second service area 14 or second cell, of a second RAT, such as NR, LTE, or similar. The second radio network node 13 may be a transmission and reception point such as an access node, an access controller, a base station, e.g. a radio base station such as a gNodeB (gNB), an evolved Node B (eNB, eNode B), a NodeB, a base transceiver station, a radio remote unit, an Access Point Base Station, a base station router, a Wireless Local Area Network (WLAN) access point or an Access Point Station (AP STA), a transmission arrangement of a radio base station, a stand-alone access point or any other network unit or node capable of communicating with a wireless device within the area served by the radio network node depending e.g. on the second radio access technology and terminology used.

Embodiments herein utilize the relation between precoding performance and the delay from channel measurement to transmission.

Contrary to prior art, a time correlation coefficient is not a monotonically decreasing function of time. Instead, the channel time correlation function is often oscillating in time. Based on this property, a scheduling decision is designed so that a communication such as a transmission for a certain UE is always scheduled to those slots which have higher correlation with the slots when CSI is measured, subject to the processing delay or feedback delay constraint, for high precoding and prediction gain.

Even if the precoder is calculated based on a stale channel information, i.e., a present channel information, it can still have high correlation with future channel information. Hence, a time correlation coefficient is determined from a channel time correlation function and then the UE 10 is scheduled based on this time correlation coefficient. The time correlation coefficient may thus be determined by calculating, obtaining, estimating or computing the time correlation coefficient.

Embodiments herein disclose a scheduling method for TDD system based on the channel time correlation function from the channel. The solution provided herein may comprise one or more of the following:
determining the time correlation coefficient in the channel time correlation function of the wireless channel based on a link measurement, or feedback information.
subject to the processing delay and latency constraint for the desired traffic, the UE may be scheduled to those slots for downlink transmission which have high time correlation coefficients with the slots when channel states are measured.
   The UEs with higher total variation of the time correlation coefficient, within a confined time duration, obtained from the previous step have higher priority to be scheduled for certain slots.
   Reciprocity based precoding may be applied on the scheduled slots.

It is to be noted that embodiments herein are described in connection with NR related examples, but embodiments herein are also applicable in other RATs.

Examples herein are illustrating embodiments when measuring channel state based on UL transmissions. However, it should be noted that embodiments herein may be implemented in any system where reference signals are measured on one link and scheduling is applied on a reverse link.

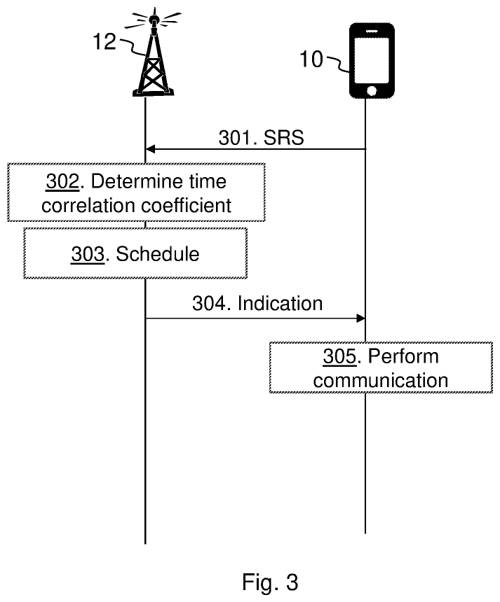

FIG. 3 is a combined signalling scheme and flowchart according to embodiments herein.

Action 301. The radio network node 12 may obtain channel measurements, such as, e.g., SRS measurements, of a transmission of the UE. For example, the radio network node 12 may receive a measurement report or perform a measurement itself.

Action 302. The radio network node 12 determines the time correlation coefficient in the channel time correlation function. The radio network node 12 may compute, estimate and/or calculate the time correlation coefficient in the channel time correlation function. The time correlation coefficient may be determined based on channel measurements.

Action 303. The radio network node 12 then schedules one or more resources for the UE 10 taking the time correlation coefficient into account.

Action 304. The radio network node 12 may then transmit to the UE 10, an indication indicating the scheduled one or more resources for the UE 10.

Action 305. The UE 10 then uses the indication to perform communication.

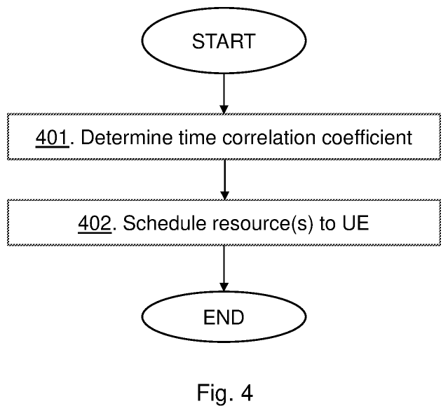

The method actions performed by the radio network node 12 for handling communication in the wireless communications network according to embodiments will now be described with reference to a flowchart depicted in FIG. 4. The actions do not have to be taken in the order stated below, but may be taken in any suitable order. Dashed boxes indicate optional features.

Action 401. The radio network node 12 determines the time correlation coefficient in the channel time correlation function.

The determined time correlation coefficient may be based on historical sounding reference signals channel estimates.

The time correlation coefficient may be estimated based on link measurements. For example, the channel time correlation function, also referred to as the autocorrelation function, may be estimated based on the UL SRS measurements. In another embodiment, the channel time correlation function may be decoded from the UE side CSI feedback.

The channel time correlation function may be computed for a timing duration related to a processing delay from a UL or DL measurement to obtaining of channel estimates and a latency constraint for the UE 10. For an interested timing duration, i.e., Δ_{d}≤τ≤Δ_{latency}, where Δ_{d} represents the processing delay (from the UL or DL measurement to the obtaining of channel estimates or feedback), Δ_{latency} represents the latency constraints for the desired UE, calculate the auto-correlation function R(T) based on state of art estimation methods.

The radio network node 12 may determine the time correlation coefficient of a time resolution, i.e., a resolution of a time domain, based on a channel estimation received at one or more slots where reference signals are sent, wherein the channel time correlation function is estimated based on either interpolating the channel estimation first, or interpolating a coarse estimated correlation function directly. For example, per SRS period time autocorrelation is estimated first, then per slot time autocorrelation is estimated further based on state of art interpolation methods. In another example, channel of each slot is estimated based on the interpolation of channel estimation at those SRS slots, then per slot time autocorrelation is obtained.

The time correlation coefficient may be based on either a sample average of historical channel measurements or a filtered version of the sample average of historical channel measurements.

The channel time correlation function for time or slot τ, R(τ), may be based on sample average of historical channel measurements and defined as:

$$R ( τ ) = \frac{1}{N - τ} {\sum }_{i = 0}^{N - 1 - τ} {h}_{i + τ} \cdot {h}_{i}^{*}$$

Here hᵢ is the channel measured at time i.

The channel time correlation function may be calculated as (i.e. non-coherently combined as)

$$R ( τ ) = \frac{1}{N - τ} {\sum }_{i = 0}^{N - 1 - τ} \vert {h}_{i + τ} \cdot {h}_{i}^{*} \vert$$

This may be to eliminate the impact of phase jump such as random phase jump.

Also, here hᵢ is the channel measured at time i.

Action 402. The radio network node 12 then schedules one or more resources for the UE 10 taking the time correlation coefficient into account.

The determined time correlation coefficient may introduce a delay in scheduling the UE 10. The delay may represent a time between a reference signal reception and a precoding applied on a reverse link, for example, between an SRS reception and a DL precoding.

The radio network node 12 may schedule the one or more resources by scheduling one or more slots for downlink transmission, which one or more slots have a channel time correlation coefficient above a level with the one or more slots when channel performance is measured.

The radio network node 12 may schedule the one or more resources by searching for a subset of time slots such that a reward on the subset of time slots is greater or equal to that on any other subsets of slots with a same cardinality, wherein said reward is obtained by a function which maps the estimated time correlation coefficients on the defined subset of time slots to a reward value, For example, searching for a subset of possible DL time slots such that a reward based on the computed time correlation coefficient over the subset is greater or equal to the reward function based on the time correlation coefficient over any other subset of the possible DL time slot with a same cardinality.

The radio network node 12 may schedule the one or more resources by, if a number of UEs to be transmitted within a slot exceeds a threshold, where the threshold is a design parameter, keeping a slot allocation decision for a UE with a higher priority than another UE.

Determine the DL slot allocation for transmission.

The determination of slot allocation outputs the DL slot range to transmit for each UE (within a time constraint) such that the time correlation coefficient is stronger with the UL measurement slots.

Step 2.a: Let [symbol] ′=[t₁, t₂, . . . t_{DL}] be the DL slot range which is to be determined. Δ_{d}≤t₁, t₂, . . . t_{DL}≤Δ_{latency}. For the sake of presentation, denote the whole available DL slots range as [symbol] =[Δ_{d}, . . . , Δ_{latency}]

The size of the set [symbol] ′ is a design parameter, which may depend on the TDD pattern, e.g., how many DL slots are available in a UL/DL TDD cycle.

For each user to be yet scheduled, search for [symbol] ′ such that

$${{\sum }_{t ∈ {𝒯}^{′}}}_{{𝒯}^{′} ⊂ 𝒯} \vert R ( t ) \vert \geq {{{{\sum }_{t ∈ {𝒯}^{′′}}}_{{𝒯}^{′′} ⊂ 𝒯}}_{\vert {𝒯}^{′} \vert = \vert {𝒯}^{′′} \vert}}_{{𝒯}^{′} \neq {𝒯}^{′′}} \vert R ( t ) \vert$$

[symbol] ′ shall be considered as the preferred DL slots range for the respective user. | [symbol] ′| denotes the size of the set [symbol] ′. [symbol] ″ is another subset of [symbol] other than [symbol] ′.

### Avoid DL Capacity Overwhelming

To avoid the extreme case that a single DL slot range is preferred for multiple UEs which may exceed the channel capacity for DL, a UE priority determination may be applied.

Step 2.b: For each UE, obtaining the total variation of the autocorrelation function in the domain of [symbol] :
In one embodiment, the total variation of the autocorrelation function is defined as:

$${𝒱}_{T} ( R ) = {sup}_{𝒫} {\sum }_{i = [ 0 : {n}_{p} - 1 ]} \vert R ( {t}_{i + 1} ) - R ( {t}_{i} ) \vert$$

Where [symbol] is the set of all partitions [symbol] ={P={t₀, t₁, . . . tₙ_{ₚ}}}, and P is a partition of the given time interval [symbol] .
In an alternative embodiment, the total variation of the autocorrelation function is defined as the total variation of the absolute value of the same autocorrelation function:

$${𝒱}_{T} ( R ) = {sup}_{P} {\sum }_{i = [ 0 : {n}_{p} - 1 ]} \vert \vert R ( {t}_{i + 1} ) \vert - \vert R ( {t}_{i} ) \vert \vert .$$

Assign high priority to the UEs with high total variation.

Step 2.c: After the determination results from step 2.a, check the following:

For a certain slot (or a plurality of slots) [symbol] ⊂ [symbol] , if the number of UEs to be transmitted within this slot exceed a threshold θ, where θ is a design parameter, then the slot allocation decision will be kept for θ₀<θ UEs with higher priority.

The slot allocation of the other UEs shall be decided based on the newly formulated slot range:

$${𝒯}_{new} = 𝒯 - \tilde{𝒯}$$

and go through steps 2.a and 2.b by replacing [symbol] with [symbol] _{new}.

Step 2.a to 2.c will be executed iteratively until ah esireJUEs are allocated to the DL slots for transmission.

### Alternative Metric in Practice.

According to the relation between throughput and the pair of time correlation and a signal-to-noise ratio (SNR), an offline metric T(R(t), s) may be obtained. Here T is throughput, R(t) is time autocorrelation, s is SNR.

For a given SNR which can be estimated based on state of art methods, the metric T(R(t), s) fallbacks to T(t). The slot allocation can be determined by replacing R(t) with T(t) and go through steps 2.a and 2.b.

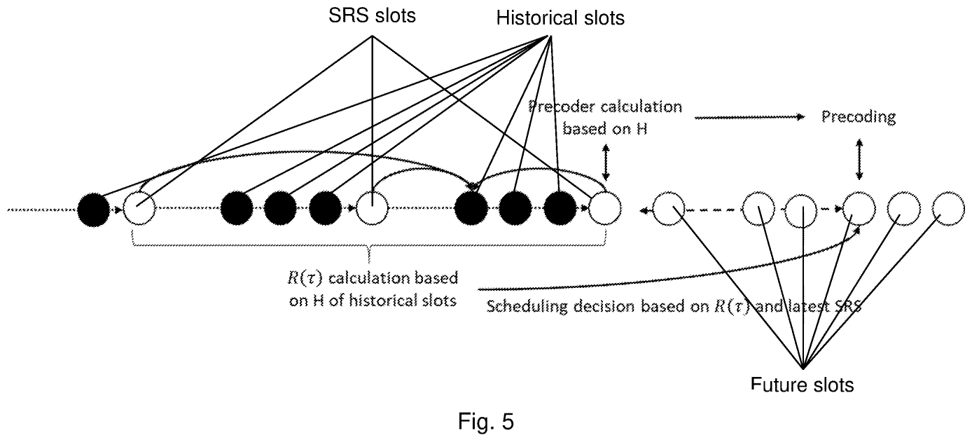

FIG. 5 shows a solution principle, wherein ‘H’ is channel estimation result based on latest SRS slot which could be a multiple dimensional tensor, e.g., with each dimension corresponding to transmission antennas, receiving antennas, frequency unit, and time unit, respectively. After collecting multiple channel estimations in the history in the historical slots, the channel time correlation function such as a time domain autocorrelation function is estimated based on the received channel measurement tensors. A high-resolution time domain autocorrelation function is estimated based on either the channel estimation on the coarse time grid when the SRS is transmitted, or the interpolated channel on the finer time grid, i.e., time resolution, when transmission slot is defined. The scheduling decision is consequently made such that the precoded DL transmission is scheduled in the future slots, which have higher correlation with the latest received SRS slot which could be in time domain or frequency domain. Thus, R(τ) calculation is based on channel estimation of historical slots and the scheduling decision may be based on the R(τ) and latest SRS.

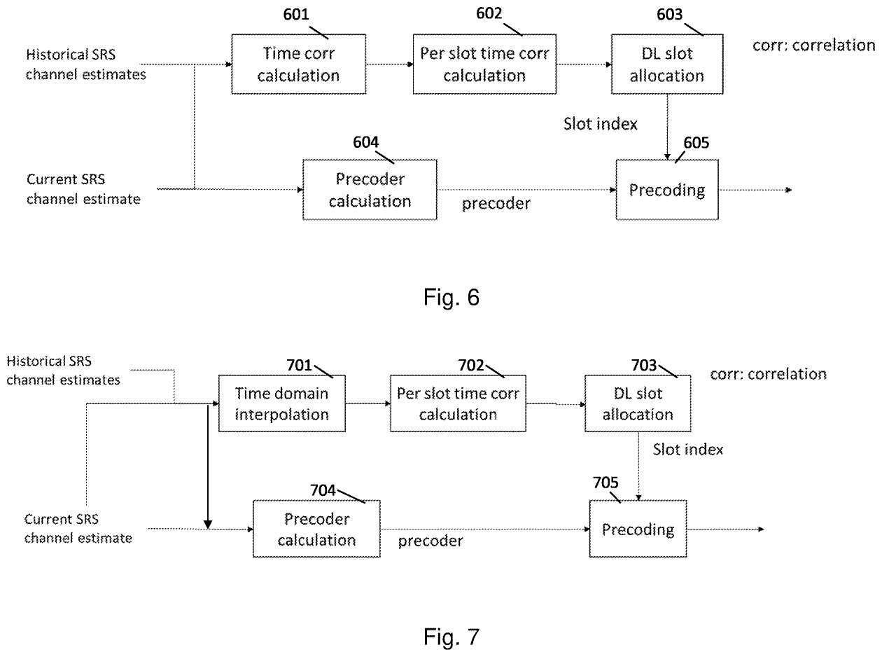

The two figures FIG. 6 and FIG. 7 show flowcharts illustrating examples of embodiments herein. A key factor is the estimation of the channel time correlation function. There are usually two ways to obtain autocorrelation which are shown in the figures.

Action 601. Current SRS channel estimates and historical SRS channel estimates are fed into the channel time correlation function.

Action 602. The time correlation (corr) coefficient may be calculated per slot.

Action 603. The DL slot allocation, i.e., the scheduling, is based on the time correlation coefficient per slot, resulting in slot index or indices.

Action 604. The current SRS channel estimates and historical SRS channel estimates are used in a precoder calculation.

Action 605. The precoding is using the precoder from the precoder calculation and slot indices from the DL slot allocation.

Action 701. Current SRS channel estimates and historical SRS channel estimates are fed into an interpolation of channel estimations at SRS slots.

Action 702. The time correlation coefficient may be calculated per slot based on the interpolated channel estimations.

Action 703. The DL slot allocation, i.e., the scheduling, is based on the time correlation coefficient per slot, resulting in slot index or indices.

Action 704. The current and historical SRS channel estimates are used in a precoder calculation.

Action 705. The precoding is using the precoder from the precoder calculation and slot indices from the DL slot allocation.

The time correlation coefficient calculation may be triggered periodically.

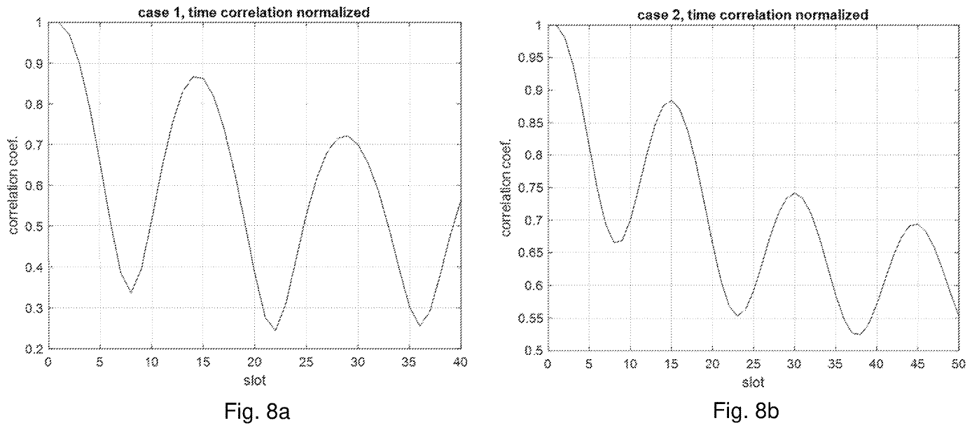

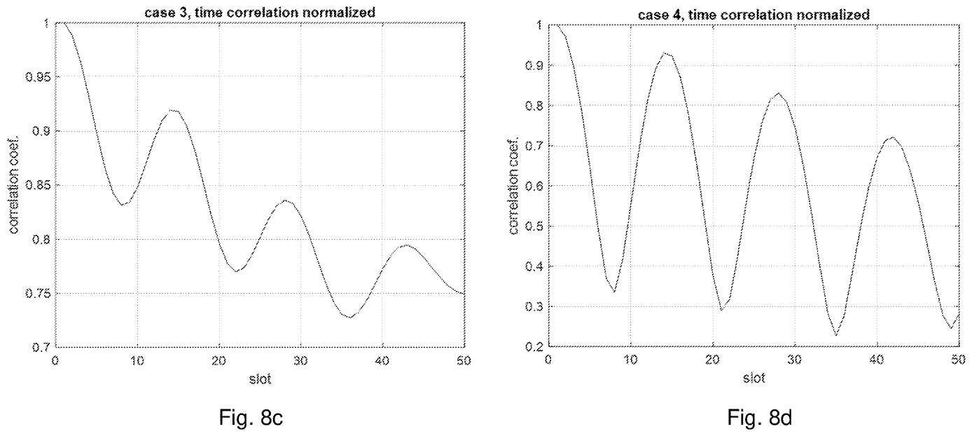

FIGS. 8a, 8b, 8c, and 8d show estimated channel time autocorrelation function of four different channel cases. The channel is traced from over the air (OTA) environment.

The four channel cases correspond to four different physical locations in the OTA measurement, respectively. A normalized time correlation coefficient is shown in each of the illustrated cases in FIGS. 8a, 8b, 8c, and 8d.

As shown in FIGS. 8a, 8b, 8c, and 8d, the time correlation coefficient is oscillating in time so that the channel of two slots with longer distance might not always be lower correlated. The determined time correlation coefficient may introduce the delay in the scheduling of the UE 10. The delay may represent the time between the reference signal reception and the precoding applied on the reverse link.

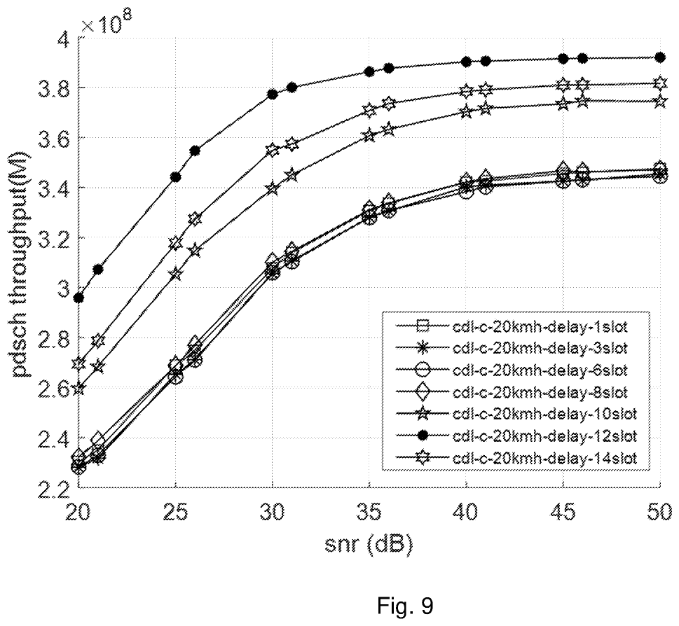

FIG. 9, illustrating a PDSCH throughout as a function of SNR, shows that the relationship between throughput and channel estimation processing delay is not simply linear. Large delay could even lead to higher throughput.

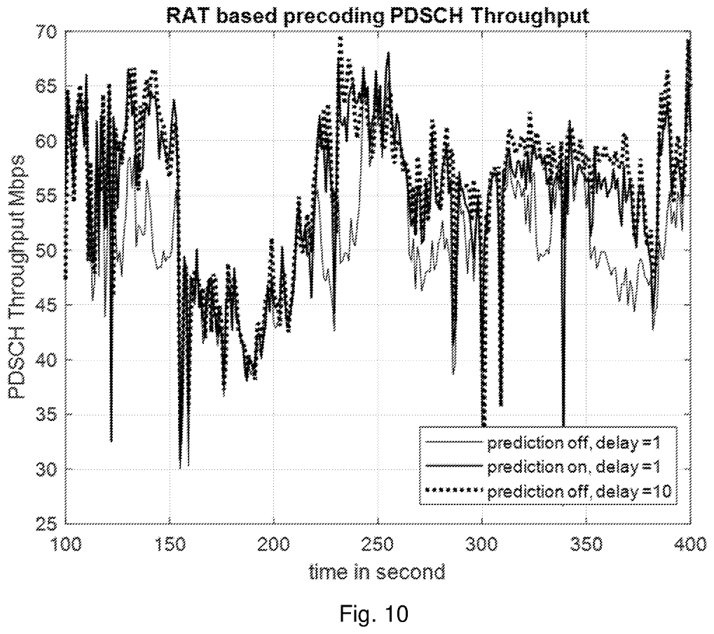

FIG. 10, illustrating a PDSCH throughout as a function of time, shows that even though channel prediction is turned off, DL throughput increases apparently if the delay parameter is designed carefully. Hereby the delay (in slots) represents the time between SRS reception and DL precoding. The simulation is performed based on real channel which is traced from OTA.

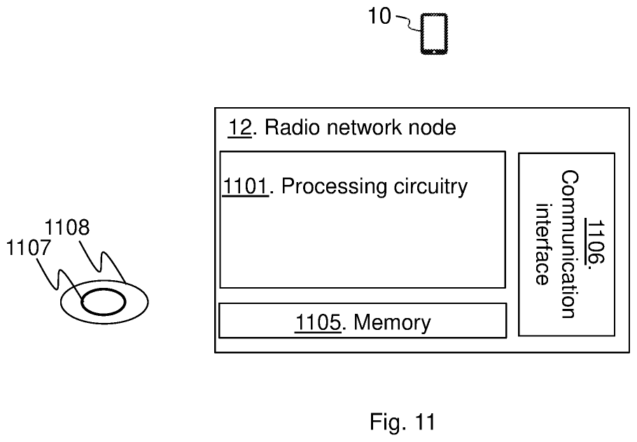

FIG. 11 is a block diagram depicting a wireless communications network 1 comprising embodiments of the radio network node 12 for handling communication.

The radio network node 12 may comprise processing circuitry 1101, e.g., one or more processors, configured to perform the methods herein.

The radio network node 12 and/or the processing circuitry 1101 is configured to determine the time correlation coefficient in the channel time correlation function. The determined time correlation coefficient may be based on historical sounding reference signals channel estimates. The channel time correlation function may be computed for a timing duration related to the processing delay from a UL or DL measurement to obtaining of channel estimates and a latency constraint for the UE. The radio network node 12 and/or the processing circuitry 1101 may be configured to determine the time correlation coefficient of the time resolution based on the channel estimation received at the one or more slots where the reference signals are sent, wherein the channel time correlation function is estimated based on either interpolating the channel estimation first, or interpolating the coarse estimated correlation function directly. The radio network node 12 and/or the processing circuitry 1101 may be configured to determine the time correlation coefficient based on either the sample average of historical channel measurements or the filtered version of the sample average of historical channel measurements. The channel time correlation function for time T may be estimated based on sample average of historical channel measurements and defined as:

$$R ( τ ) = \frac{1}{N - τ} {\sum }_{i = 0}^{N - 1 - τ} {h}_{i + τ} \cdot {h}_{i}^{*}$$

The channel time correlation function may be calculated as

$$R ( τ ) = \frac{1}{N - τ} {\sum }_{i = 0}^{N - 1 - τ} \vert {h}_{i + τ} \cdot {h}_{i}^{*} \vert$$

The radio network node 12 and/or the processing circuitry 1101 is configured to schedule the one or more resources for a user equipment taking the time correlation coefficient into account. The determined time correlation coefficient may introduce a delay in scheduling the UE. The delay may represent a time between a reference signal reception and a precoding applied on a reverse link. The radio network node 12 and/or the processing circuitry 1101 may be configured to schedule the one or more resources by scheduling one or more slots for downlink transmission, which one or more slots have a channel time correlation coefficient above a level with the one or more slots when channel performance is measured. The radio network node 12 and/or the processing circuitry 1101 may be configured to schedule the one or more resources by searching for a subset of time slots such that a reward on the subset of time slots is greater or equal to that on any other subsets of slots with a same cardinality, wherein said reward is obtained by a function which maps the estimated time correlation coefficients on the defined subset of time slots to a reward value. For example, by searching for the subset of possible DL time slots such that a reward function based on the computed time correlation coefficient over the subset is greater or equal to the reward function based on the time correlation coefficient over any other subset of the possible DL time slot with a same cardinality. The radio network node 12 and/or the processing circuitry 1101 may be configured to keep, if a number of UEs to be transmitted within a slot exceeds a threshold, where the threshold is a design parameter, a slot allocation decision for a UE with a higher priority than another UE.

The radio network node 12 may comprise a memory 1105. The memory 1105 may comprise one or more units to be used to store data on, such as data packets, delay indications, measurements, scheduling information, indicators, one or more conditions, mobility events, measurements, events and applications to perform the methods disclosed herein when being executed, and similar. Furthermore, the radio network node 12 may comprise a communication interface 1106 such as comprising a transmitter, a receiver, a transceiver and/or one or more antennas.

The methods according to the embodiments described herein for the radio network node 12 are respectively implemented by means of, e.g., a computer program product 1107 or a computer program, comprising instructions, i.e., software code portions, which, when executed on at least one processor, cause the at least one processor to carry out the actions described herein, as performed by the radio network node 12. The computer program product 1107 may be stored on a computer-readable storage medium 1108, e.g., a disc, a universal serial bus (USB) stick or similar. The computer-readable storage medium 1108, having stored thereon the computer program product, may comprise the instructions which, when executed on at least one processor, cause the at least one processor to carry out the actions described herein, as performed by the radio network node 12. In some embodiments, the computer-readable storage medium may be a transitory or a non-transitory computer-readable storage medium. Thus, embodiments herein may disclose a radio network node 12 for handling communication in a wireless communications network, wherein the radio network node 12 comprises processing circuitry and a memory, said memory comprising instructions executable by said processing circuitry whereby said radio network node 12 is operative to perform any of the methods herein.

In some embodiments, a more general term “radio network node” is used, and it can correspond to any type of radio-network node or any network node, which communicates with a wireless device and/or with another network node. Examples of network nodes are NodeB, MeNB, SeNB, a network node belonging to Master cell group (MCG) or Secondary cell group (SCG), base station (BS), multi-standard radio (MSR) radio node such as MSR BS, eNodeB, gNodeB, network controller, radio-network controller (RNC), base station controller (BSC), relay, donor node controlling relay, base transceiver station (BTS), access point (AP), transmission points, transmission nodes, Remote radio Unit (RRU), Remote Radio Head (RRH), nodes in distributed antenna system (DAS), etc.

In some embodiments, the non-limiting term wireless device or user equipment (UE) is used, and it refers to any type of wireless device communicating with a network node and/or with another wireless device in a cellular or mobile communication system. Examples of UE are target device, device to device (D2D) UE, proximity capable UE (aka ProSe UE), machine type UE or UE capable of machine to machine (M2M) communication, Tablet, mobile terminals, smart phone, laptop embedded equipped (LEE), laptop mounted equipment (LME), USB dongles, etc.

Embodiments are applicable to any RAT or multi-RAT systems, where the wireless device receives and/or transmit signals (e.g. data) e.g. New Radio (NR), Wi-Fi, Long Term Evolution (LTE), LTE-Advanced, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations.

As will be readily understood by those familiar with communications design, that functions means or circuits may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a wireless device or network node, for example.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware and/or program or application data. Other hardware, conventional and/or custom, may also be included. Designers of communications devices will appreciate the cost, performance, and maintenance trade-offs inherent in these design choices.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

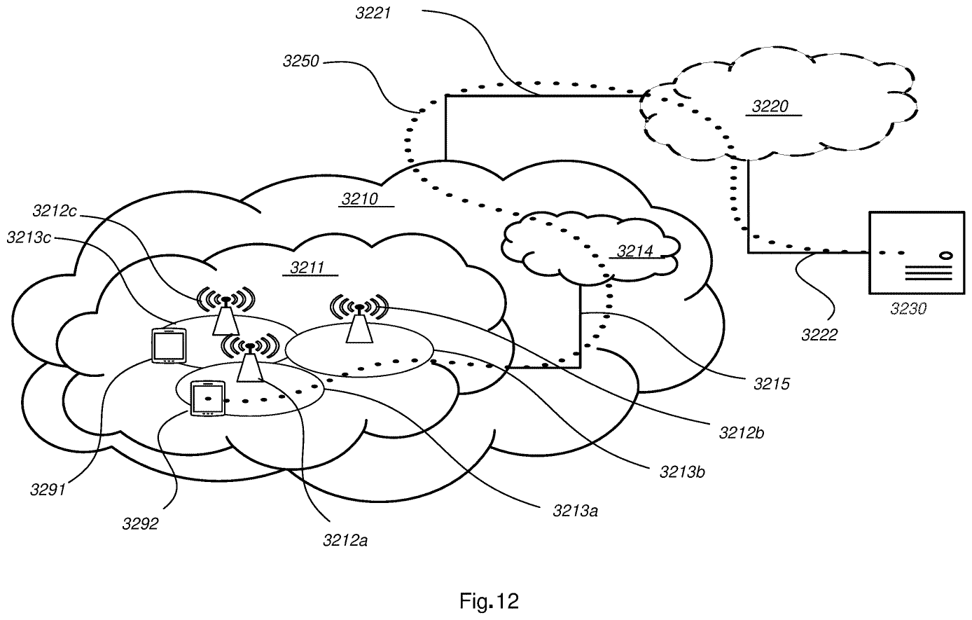

With reference to FIG. 12, in accordance with an embodiment, a communication system includes a telecommunication network 3210, such as a 3GPP-type cellular network, which comprises an access network 3211, such as a radio access network, and a core network 3214. The access network 3211 comprises a plurality of base stations 3212a, 3212b, 3212c, such as NBs, eNBs, gNBs or other types of wireless access points being examples of the radio network node 12 herein, each defining a corresponding coverage area 3213a, 3213b, 3213c. Each base station 3212a, 3212b, 3212c is connectable to the core network 3214 over a wired or wireless connection 3215. A first user equipment (UE) 3291, being an example of the UE 10, located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 12 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

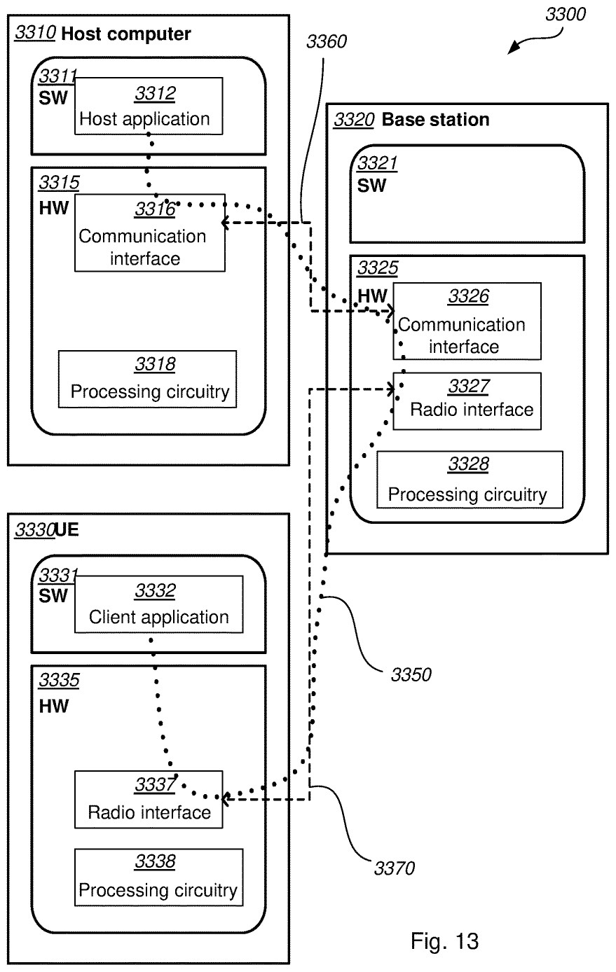

Example implementations, in accordance with an embodiment, of the UE, base station and host computer discussed in the preceding paragraphs will now be described with reference to FIG. 13. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 13) served by the base station 3320. The communication interface 3326 may be configured to facilitate a connection 3360 to the host computer 3310. The connection 3360 may be direct or it may pass through a core network (not shown in FIG. 13) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 13 may be identical to the host computer 3230, one of the base stations 3212a, 3212b, 3212c and one of the UEs 3291, 3292 of FIG. 12, respectively. This is to say, the inner workings of these entities may be as shown in FIG. 13 and independently, the surrounding network topology may be that of FIG. 12.

In FIG. 13, the OTT connection 3350 has been drawn abstractly to illustrate the communication between the host computer 3310 and the user equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing, e.g., on the basis of load balancing consideration or reconfiguration of the network.

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the performance since radio optimization may be performed more accurately and thereby provide benefits such as reduced user waiting time, and better responsiveness.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

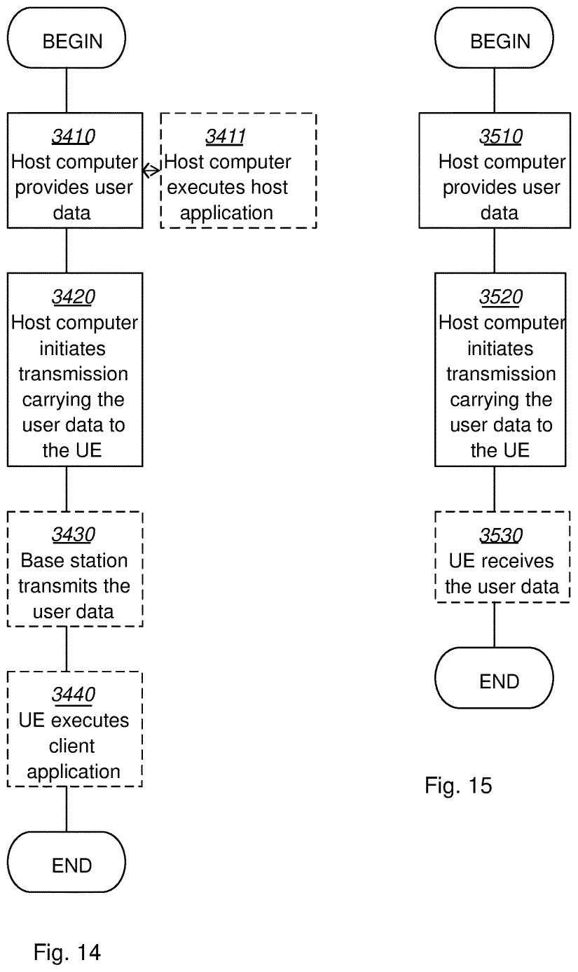

FIG. 14 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 14 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 15 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 15 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

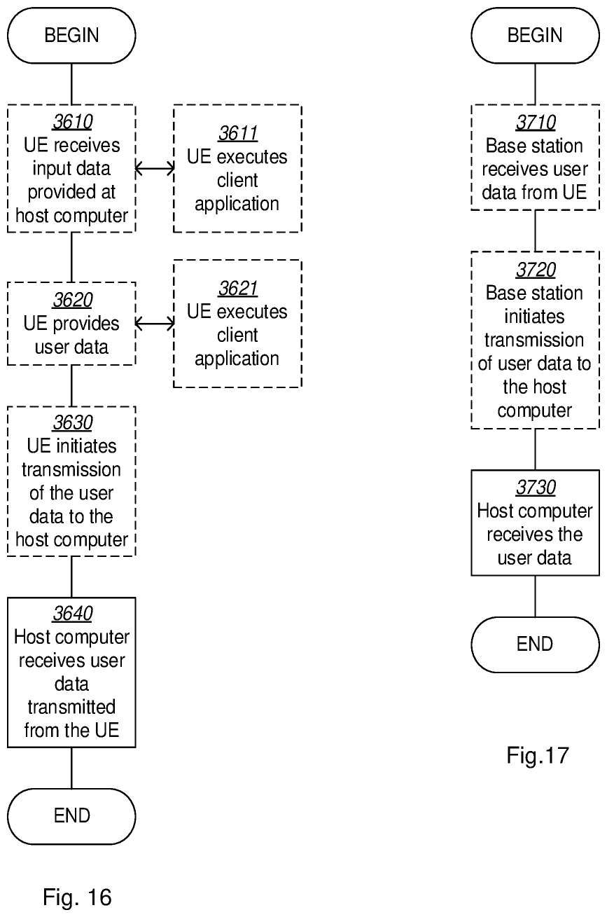

FIG. 16 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 16 will be included in this section. In an optional first step 3610 of the method, the UE receives input data provided by the host computer. Additionally or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

FIG. 17 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 17 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

1-26. (canceled)

27. A method performed by a radio network node for handling communication in a wireless communication network, the method comprising:
determining a time correlation coefficient in a channel time correlation function; and
scheduling one or more resources for a user equipment (UE) taking the time correlation coefficient into account.

28. The method of claim 27, wherein the determined time correlation coefficient introduces a delay in scheduling the UE.

29. The method of claim 28, wherein the delay represents a time between a reference signal reception and a precoding applied on a reverse link.

30. The method of claim 27, wherein the determined time correlation coefficient is based on historical sounding reference signals channel estimates.

31. The method of claim 27, wherein the channel time correlation function is computed for a timing duration related to a processing delay from an Uplink (UL) or Downlink (DL) measurement to obtaining of channel estimates and a latency constraint for the UE.

32. The method of claim 27, wherein scheduling the one or more resources comprises scheduling one or more slots for downlink transmission, which one or more slots have a channel time correlation coefficient above a level with the one or more slots when channel performance is measured.

33. The method of claim 27, wherein determining the time correlation coefficient of a time resolution is based on a channel estimation received at one or more slots where reference signals are sent, wherein the channel time correlation function is estimated based on either interpolating the channel estimation first, or interpolating a coarse estimated correlation function directly.

34. The method of claim 27, wherein determining the time correlation coefficient is based on either a sample average of historical channel measurements or a filtered version of the sample average of historical channel measurements.

35. The method of claim 27, wherein the channel time correlation function (R(τ)) is based on sample average of historical channel measurements and defined as:
$$R ( τ ) = \frac{1}{N - τ} {\sum }_{i = 0}^{N - 1 - τ} {h}_{i + τ} \cdot {h}_{i}^{*}$$
wherein hᵢ is a channel measured at time i, or
wherein R(τ) is calculated as
$$R ( τ ) = \frac{1}{N - τ} {\sum }_{i = 0}^{N - 1 - τ} \vert {h}_{i + τ} \cdot {h}_{i}^{*} \vert$$
wherein hᵢ is the channel measured at time i.

36. The method of claim 27, wherein scheduling the one or more resources comprises searching for a subset of time slots such that a reward on the subset of time slots is greater or equal to that on any other subsets of slots with a same cardinality, wherein said reward is obtained by a function which maps the estimated time correlation coefficients on the defined subset of time slots to a reward value.

37. The method of claim 27, wherein scheduling one or more resources comprises, if a number of UEs to be transmitted within a slot exceeds a threshold, where the threshold is a design parameter, keeping a slot allocation decision for a UE with a higher priority than another UE.

38. A radio network node for handling communication in a wireless communication network, wherein the radio network node is configured to:
determine a time correlation coefficient in a channel time correlation function; and
schedule one or more resources for a user equipment (UE) taking the time correlation coefficient into account.

39. The radio network node of claim 38, wherein the determined time correlation coefficient introduces a delay in scheduling the UE.

40. The radio network node of claim 39, wherein the delay represents a time between a reference signal reception and a precoding applied on a reverse link.

41. The radio network node of claim 38, wherein the determined time correlation coefficient is based on historical sounding reference signals channel estimates.

42. The radio network node of claim 38, wherein the channel time correlation function is computed for a timing duration related to a processing delay from an Uplink (UL) or Downlink (DL) measurement to obtaining of channel estimates and a latency constraint for the UE.

43. The radio network node of claim 38, wherein the radio network node is configured to schedule the one or more resources by scheduling one or more slots for downlink transmission, which one or more slots have a channel time correlation coefficient above a level with the one or more slots when channel performance is measured.

44. The radio network node of claim 38, wherein the radio network node is configured to determine the time correlation coefficient of a time resolution based on a channel estimation received at one or more slots where reference signals are sent, wherein the channel time correlation function is estimated based on either interpolating the channel estimation first, or interpolating a coarse estimated correlation function directly.

45. The radio network node of claim 38, wherein the radio network node is configured to determine the time correlation coefficient based on either a sample average of historical channel measurements or a filtered version of the sample average of historical channel measurements.

46. The radio network node of claim 38, wherein the channel time correlation function (R(τ)) is estimated based on sample average of historical channel measurements and defined as:
$$R ( τ ) = \frac{1}{N - τ} {\sum }_{i = 0}^{N - 1 - τ} {h}_{i + τ} \cdot {h}_{i}^{*}$$
wherein hᵢ is the channel measured at time i, or
wherein R(τ) is calculated as
$$R ( τ ) = \frac{1}{N - τ} {\sum }_{i = 0}^{N - 1 - τ} \vert {h}_{i + τ} \cdot {h}_{i}^{*} \vert$$
wherein hᵢ is the channel measured at time i.
